(19) United States
(12) Patent Application Publication
(10) Pub. No.: US 2008/0104034 A1
(43) Pub. Date: May 1, 2008

(54) Method For Scoring Changes to a Webpage

(76) Inventors: Jeffrey A. Stewart, New York, NY (US); Shera Ahmad, Rego Park, NY (US)

Correspondence Address: FISH & RICHARDSON P.C., P.O. BOX 1022, MINNEAPOLIS, MN, 55440-1022, US

(21) Appl. No.: 11/754,887

(22) Filed: May 29, 2007

Related U.S. Application Data
(60) Provisional application No. 60/808,574, filed on May 26, 2006.
(60) Provisional application No. 60/892,945, filed on Mar. 5, 2007.

(51) Int. Cl. G06F 7/06

(52) U.S. Cl. 707/3; 707/E17.014

(57) ABSTRACT

The present invention provides for a system and method for evaluating changes to internet content wherein content is harvested from Internet sources and the harvested content includes changed content. The harvested content is filtered and analyzed using one or more keyword analyses based on a predetermined list of one or more keywords. A quality score is determined based on the relative occurrence of the one or more keywords within or associated with the harvested content.

### CLAIM OF PRIORITY

This application claims the benefit of priority to U.S. Provisional Application No. 60/808,574, filed May 26, 2006, and to U.S. Provisional Application No. 60/892,945, filed Mar. 5, 2007, both of which are incorporated herein by reference in their entirety.

### TECHNICAL FIELD

The present invention generally relates to methods of evaluating differences in content posted over a network, such as the Internet.

### BACKGROUND

Meaningful and actionable information is often posted to the Internet before it is available on traditional information sources such as news wire services or cable news networks. For example, problems with a new product or a delayed launch date are often discussed in Internet chat rooms and blogs before such information is disseminated by a news wire service. Identifying new content or changes to content in large data sets is significant to an analyst because often the most interesting piece of information is the new information. Previous methods for analyzing changes to content on the Internet have ultimately relied on human inspection of the highlighted changes to determine the quality and relevance of the changes with regard to predetermined parameters. An analyst may benefit from the efficient notification and evaluation of changes to content posted on various Internet sources. For example, the extent to which newly posted content or changes to existing content relate to predetermined categories of interest would facilitate the efficient and rapid review and analysis of such content.

Accordingly, there is a need for a method of efficiently evaluating changes to content by automatically identifying and analyzing changes to content that may be of interest. More specifically, there is a need to determine the quality of changes to content posted on the Internet or other networks wherein the quality of the changes is based on the relative occurrence of predetermined keywords.

The discussion of the background to the invention herein is included to explain the context of the invention. This is not to be taken as an admission that any of the material referred to was published, known, or part of the common general knowledge as at the priority date of any of the claims.

Throughout the description and claims of the specification the word “comprise” and variations thereof, such as “comprising” and “comprises”, is not intended to exclude other additives, components, integers or steps.

### SUMMARY

The present invention addresses a method of efficiently evaluating changes to content by automatically identifying and analyzing changes to content that may be of interest. A method is provided for determine the quality of changes to content posted on the Internet or other networks wherein the quality of the changes is based on the relative occurrence of predetermined keywords.

The present invention provides a method for evaluating changes to internet content comprising: harvesting content wherein the content includes changed content; filtering the harvested content; performing one or more keyword analyses on the harvested content from a predetermined list of one or more keywords; and calculating a score based on the one or more keyword analyses.

The present invention further provides for a method for evaluating changes to internet content comprising: harvesting content wherein the content includes changed content; filtering the harvested content; performing a first keyword analysis, second keyword analysis, a third key word analysis and a fourth keyword analysis on the harvested content from a predetermined list of one or more keywords; and calculating a score based on the first, second, third, and fourth keyword analyses.

The present invention provides for a system for evaluating changes to internet content comprising: a content harvester; a content quality calculator; means within content harvestor for acquiring content having changed content; means for analyzing the acquired content and changed content for the occurrence of predetermined keywords; means for determining a quality score associated with the changed content; and means for displaying the content, the changed content, and the quality score.

### BRIEF DESCRIPTION OF THE DRAWINGS

FIG. 1 shows an exemplary system according to an implementation of the present invention;

FIG. 2 shows an exemplary system according to an implementation of the present invention;

FIG. 3 shows an exemplary system according to an implementation of the present invention; and

FIG. 4 shows a flow-chart of an exemplary method of the present invention.

### DETAILED DESCRIPTION

The present invention addresses the need for a system and method to identify and evaluate changes to traditional and non-traditional sources of information and content available on the Internet. As described herein, systems and methods are provided for automatically identifying changes to content posted on a network, such as the Internet, and evaluating the quality of the changes with respect to predetermined criteria. As used herein, content changes or changes to content includes newly posted content, deleted content, added content, and the like.

In an implementation, a method is provided for determining the quality of changes to existing content or newly posted content available over a network, such as the Internet, wherein a quality score is based on the relative occurrence of predetermined keywords.

In an implementation, content, in the form of RSS feeds or raw HTML information, is pulled from identified web sites on the World Wide Web, or other Internet sources. The content is evaluated to determine the credibility and trusted authoritativeness of the content. Changes to the content in the form of additions, deletions, or updates from the last posting are identified. The changes are filtered to remove predictable or irrelevant changes from the identified changes to the content. A keyword analysis is then performed on the identified changes to determine a quality score. Additional keyword analyses can be performed, for example, on the content surrounding the identified changed content, the content surrounding any identified key words, content within the same URL as the identified changed content, and any keywords found within meta-data, tags, headers or titles associated with the identified changed content. All keyword analyses may be scored to determine an overall quality score for the changed content. The quality score and/or the content are displayed on a display and interface.

In this manner an industry analyst, financial analyst, or other business intelligence professional is able to efficiently identify and evaluate changes to posted content or additions to content found on a webpage, blog posting, or other internet source that is associated with a particular company, industry sector, common area of interest or common theme.

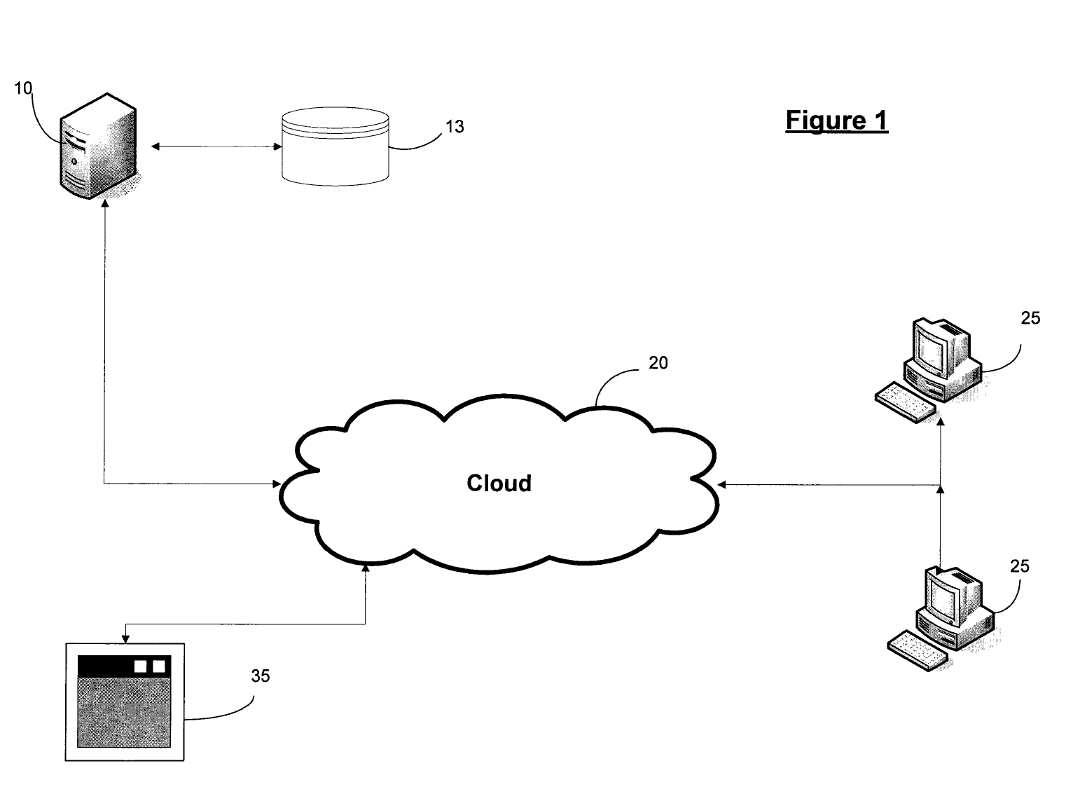

FIG. 1 is a diagram illustrating an exemplary system consistent with the concepts discussed herein. The system includes a server 10, a network 20, multiple user terminals 25, and an update service 35. Network 20 may be the Internet or any other computer network. User terminals 25 each include a computer readable medium, such as random access memory, coupled to a processor, and a user interface displayed on a display. User terminals 25, may also include a number of additional external or internal devices, such as, without limitation, a mouse, a CD-ROM, and a keyboard.

Server 10 communicates with user terminals 25 and update service 35 via network 20. Server 10 may include a processor coupled to a computer readable memory. Server 10 may additionally include one or more secondary storage devices 13, such as a database.

The server and user terminal processors can be any of a number of well known computer processors, such as processors from Intel Corporation of Santa Clara, Calif. In general, user terminal 25 may be any type of computing platform connected to a network and that interacts with application programs, such as a personal computer, personal digital assistant, or a smart cellular telephone. Server 10, although depicted as a single computer system, may be implemented as a network of computer processors, as is well known in the art.

In an implementation the computer readable memory of server 10 includes a content change tracking program, which pulls content from pre-identified sources on the Internet or other network in response to an update file received from an updating service 35. The content change tracking program or updating service 35 can include a web crawler or similar program for searching the Internet for content changes. Updating service 35 may communicate with server 10 via network 20 or may be integral to server 10.

An implementation of the content change tracking program includes an acquisition or harvesting function, an evaluation and content processing function, and a distribution function. The harvesting function pulls content from identified sources and normalizes the content for further categorization and analysis. The harvesting function may identify changes to preexisting content or identify new content found on the content source, such as a web page.

The content analyzing and processing function evaluates the content from the acquisition program to determine, among other things, the source type, source reputation, content reputation, author, posting histories, and changes to the content as well as analysis of such changes to the content. Those skilled in the art will appreciate that any number of processing methods may be incorporated into the content analyzing and processing function. A more detailed description of some of the functionalities implemented by the content tracking program, including the harvesting function, the evaluation and content processing function and the display function is provided below.

Content Acquisition and Harvesting Function:

In an implementation content is harvested for evaluation of changes or additions to the content. For example, content from a webpage may be pulled based off a predetermined schedule or a notification event. A base text analysis is performed to catalog the content for future analysis. At some later time the content from the same source is pulled and analyzed to detect the textual differences between the content of the first pull and the content of the second pull. Any textual changes, either by addition or deletion are identified and cataloged for additional evaluation.

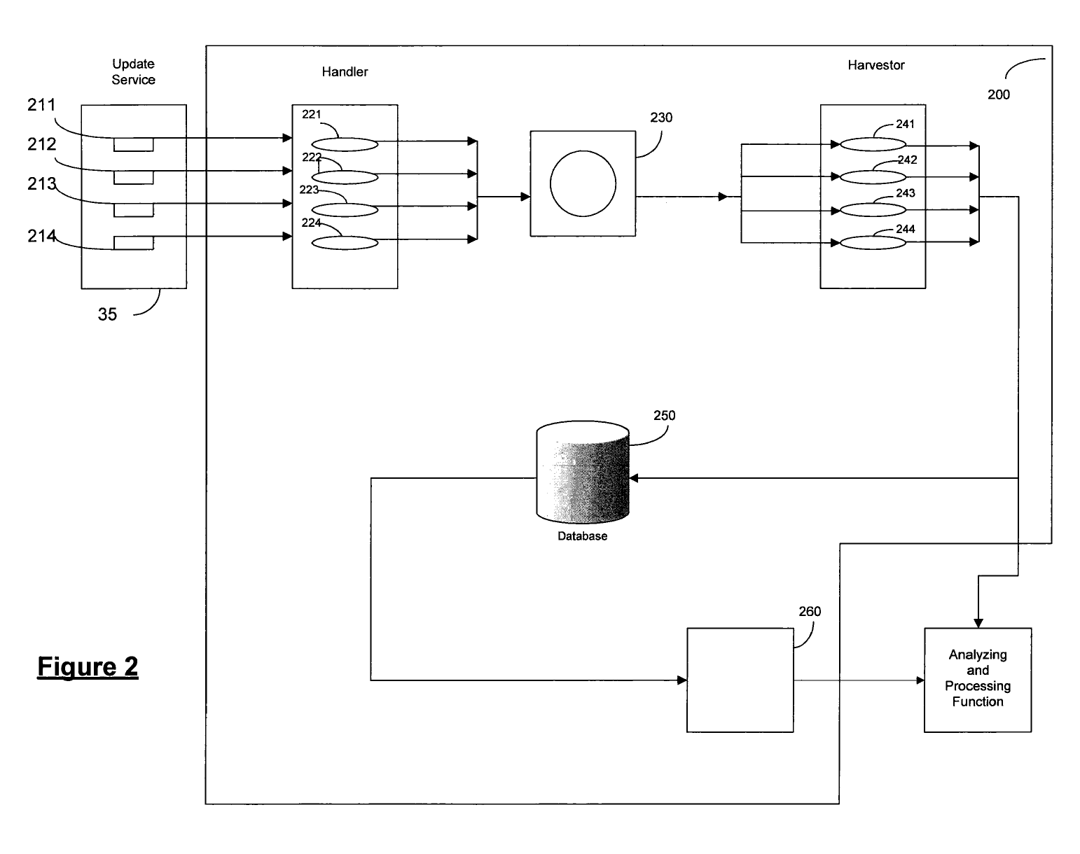

According to the implementation of FIG. 2, a content acquisition or harvesting function 200 may include multiple data sources 211-214, a number of feed handlers 221-224, a raw data message queue 230, multi-threaded harvesters 241-244, a data store 250, and a playback service 260.

The multiple data sources may form updating service 35 or may be integral to the acquisition program. The data sources 211-214 transmit notifications of new, updated or recently changed web content to the feed handlers 221-224 and may include, for example, a feed mesh consisting of one or more open or proprietary ping servers. Many blog authoring tools automatically send a signal or “ping” to one or more servers each time the blogger creates a new post (or updates/changes an old one.) That is, the blog authoring tool sends an XML-RPC signal to one or more “ping servers,” which can then generate a list of blogs that have new material.

Open ping servers, like Verisign's Weblogs.com and Yahoo!'s blo.gs, let other web-services subscribe to a list of blogs that have recently pinged them. Blog search engines can provide fresh results very quickly by polling only the newly-updated blogs. Similarly, aggregators use results from ping servers to tell subscribers which items on their subscription lists have fresh material. A few of the blog aggregators that can be pinged directly include: BulkFeeds, FeedBurner, Google Blog Search, IceRocket, Technorati, Yahoo, and ZingFast.

The ping servers receive and collect XML-RPC signals, or pings, from other websites indicating that they have posted new content or updated existing content. After receiving a ping from one of these websites, a ping server may transmit a notification to a live feed handler 221, 222 in real time or close to real time (i.e., as a ping is received from a website), or it may store the notification and send it as part of a batch of notifications for transmission at a later time to a batch feed handler 223, 224. If the notification is transmitted in real time or close to real time, the ping server that sends the notification acts as a live data source 211, 212. On the other hand, if notifications are first collected and then transmitted at the same time, the ping server acts as a batch data source 213, 214.

Many different kinds of websites spanning a wide range of interests and categories may be monitored for new or updated content. For instance, these websites may include weblogs posted by an individual or a group of individuals, message boards, traditional news sites, interest group websites, company websites, or government sites. In addition, these websites may be part of a general list of publishers or content providers kept by the ping servers, or they may be a specific subset of websites that have been selected for monitoring. Because the Internet contains a vast amount of such publishers and content providers that may be posting new or updated content at any one point in time, in practice numerous data sources may be transmitting notifications to a large number of feed handlers 221-224, although only four data sources and four feed handlers are shown in the implementation of FIG. 2.

A notification from the update service 35 via data sources 211-214 that one or more websites of interest has new or updated content may be transmitted as part of an Extensible Markup Language (XML) file. The contents and format of the XML file may vary depending on the data source from which it originates or the website to which the notification relates. In some cases, only an XML snippet indicating where the new or updated content may be retrieved is transmitted to the feed handlers 221-224. An XML snippet may contain, for example, a Uniform Resource Identifier (URI) identifying the location of a Really Simple Syndication (RSS) feed of a website or, in some cases, only a link to the main page of the website itself or some other general page. Also in some cases, a small amount of information about the subject matter of the new or updated content may be included.

Although the foregoing examples and the following description describes implementations with respect to websites that syndicate their content with RSS feeds, it should be noted that the implementations are not limited to any particular web feed format. For example, websites with web feeds that conform to the Atom syndication specification, including those expressed in Web Ontology Language (OWL), also may be monitored for new or updated content. In addition, if a website does syndicate its content with an RSS feed, the implementations described are not limited to any particular RSS feed format (e.g., RSS 0.91, RSS 0.92, or RSS 2.0).

Returning to the implementation of FIG. 2, the feed handlers that receive the notifications from the data sources 211-214 may include live feed handlers 221, 222 for receiving notifications from the live data sources 211, 212 and batch feed handlers 223, 224 for receiving notifications from the batch data sources 213, 214. The notifications may be received as a result of being pushed by the data sources 211-214 to the feed handlers 221-224. In addition, the feed handlers 221-224 may pull the notifications from the data sources 211-214 at designated intervals of time or in response to a command.

As described above, a large number of notifications may be transmitted to the feed handlers at the same time by numerous data sources. In order to facilitate acquisition of the notifications in real-time or close to real-time, several feed handlers 221-224 are shown operating in parallel to receive different notifications. Also as described above, the notifications that are received by the feed handlers 221-224 may vary in content and format due to the potentially large number of data sources, many of which may be for example unrelated third party ping servers. As a result, the feed handlers 221-224 normalize the notifications to conform to a standard that is convenient for processing in later steps.

After the feed handlers 211-214 receive and normalize the notifications, the notifications are sent to the raw data message queue 230. The raw data message queue 230 may be, for example, a Java Message Service (JMS) server, also known as a message broker, acting as an intermediary that receives normalized notifications from the feed handlers 221-224 (the JMS producers) and dispatches the notifications to the harvesters 231-234 (the JMS clients). Since the feed handlers 211-214 may operate in parallel, a large number of notifications may be sent from the feed handlers 211-214 to the raw data message queue 230 at the same time. The raw data message queue 230 puts the notifications in a queue in the order in which they were received. Each notification in the queue then is sent by the raw data message queue 230 to only one of the harvesters 231-234.

Various commercial or open source Java Message Service (JMS) servers may be utilized to implement the raw data message queue 230. Since a notification that is put into the queue is sent to only one of the harvesters 241-244, the raw data message queue 530 should be able to operate according to a point-to-point messaging model. Examples of JMS servers that may be used include FioranoMQ, SonicMQ, ActiveMQ, MSMQ, and OpenJMS.

Using the information contained in the notifications, the harvesters 241-244 determine whether the notifications indeed identify websites that have posted new or updated/changed content and, if they have, retrieve the content from the websites. As described in greater detail below, depending on a number of factors, the harvesters 241-244 may need to perform a number of operations and the time that the harvesters 241-244 take to complete their operations may vary.

Harvesters 241-244 may be multi-threaded and operate in parallel so that each harvester receives a different notification from the raw data message queue 230. As with the data sources 211-214 and the feed handlers 221-214, although the implementation of FIG. 2 shows only four harvesters 241-244, in practice almost any number of harvesters may be used.

In a first step to determining whether a website has new or updated content, a harvester examines a notification for a URI indicating the location of the content or the website. If a URI is found, the harvester may screen the URI for undesirable websites or content. For example, the harvester may compare the URI against a predetermined list of websites that are to be avoided. Such undesirable websites may include those that are known to be producers of spam or websites with a specific generic top-level domain (gTLD) such as “.biz”.

If the URI does not indicate a location that is to be avoided, the harvester initiates a first harvest by pulling an RSS feed from that location. However, as discussed above, in some cases the URI may only indicate the location of a website's the main page or some other general webpage. If that is the case, the harvester also may perform a feed discovery function in which it searches for the website's RSS feed, which the harvester then pulls.

Next, the harvester indexes to the section of the RSS feed in which information about new or updated content may be found.

If the harvester determines that the website does indeed have new or updated content, the harvester may perform a secondary harvest by pulling the content from the website. The content may be normalized by the harvester if it does not conform to a standard that is convenient for processing by the system. After any such normalization, an XML object file may be created for compiling information relating to the content. In one implementation, the file may contain headings for the content's title, author, date of publication, date of last revision, main page, and subject matter. If the content already contains such information and may be extracted at this point, the proper headings are filled in. Other information that is not so readily available may be inserted in later steps, for example while the harvested data is in a natural language pipeline (NLP).

The harvesters 241-244 may either send the XML object files and the harvested content to the content analyzing and processing function, a data store 250, or both. The data store 250 is a storage system, for example a system of on- or off-site disk devices, used to store the XML object files and the harvested content. Such a storage system may be included as backup in case an error occurs in a later step and certain data needs to be reloaded. The data store 250 may alleviate the need to re-acquire the content from an outside website, which may cost both time and money. If for some reason the content needs to be processed by a harvester again, the data store 250 may retrieve the stored data and send it to the raw data message queue 230, which in turn dispatches the content to one of the harvesters 241-244. In addition, the backup of the content or XML file created for that content may be sent to a playback service 260. The playback service 260 then sends the data to the content analyzing and processing function of the content change tracking program.

Content Analysis and Processing Function:

An implementation of a method of processing the harvested content includes: queuing the harvested content for processing; converting the queued content for parallel processing; analyzing the content in one or more natural language processors including evaluating the quality of the changed content, queuing the analysis of the content with the harvested content, collating the analysis of the content with the harvested content to produce an analyzed harvested content file, and queuing the analyzed harvested content file for further handling, indexing, categorizing and display.

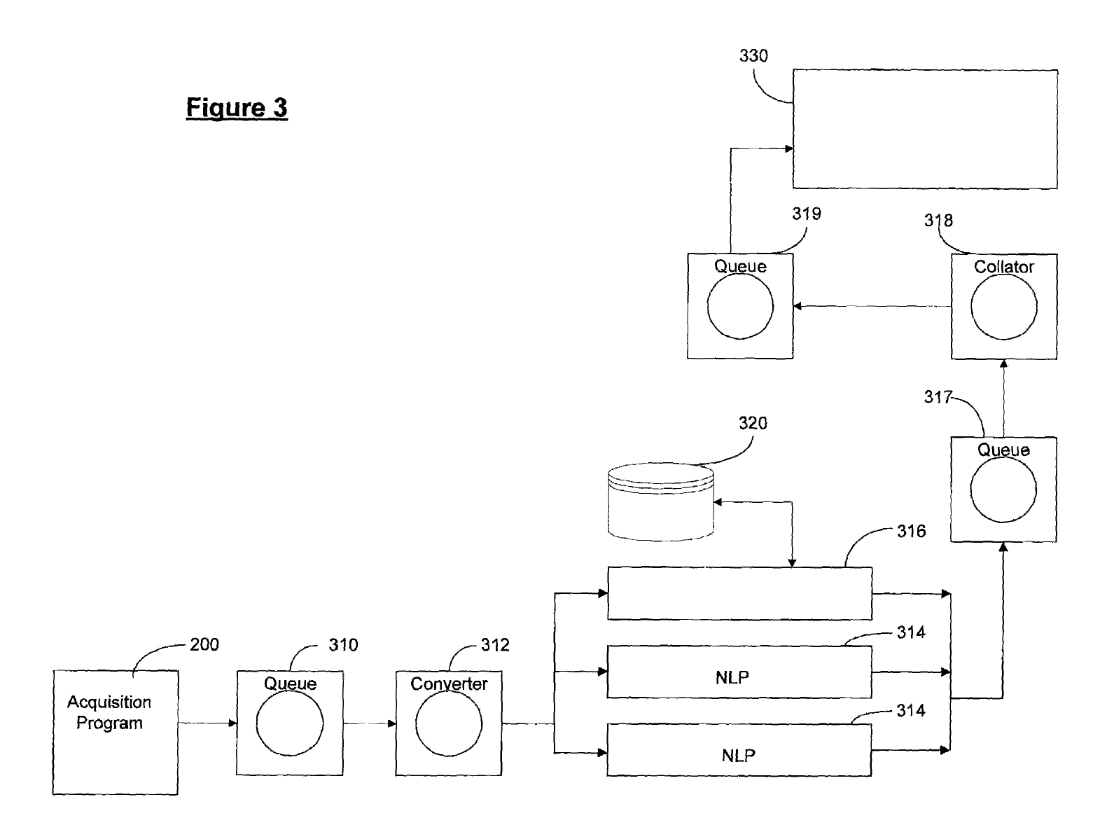

FIG. 3 depicts an implementation of a system for the content analyzing and processing function and may include a harvested data message queue 310, a queue-topic converter 312, one or more natural language processors 314, a natural language processor queue 317, a collator 318, and a collated data queue 319.

Like the raw data message queue 230 described above, the harvested data message queue 310, the natural language processor queue 317, and the collated data queue 319 may be, for example, a Java Message Service (JMS) server, or message broker. The harvested data message queue 310 may act as an intermediary that receives harvested data from the harvesters 241-244 (the JMS producers) and dispatches to a queue-topic converter 312 (the JMS client). The natural language processor queue 317 may act as an intermediary that receives processed data from the one or more natural language processors 314 (the JMS producers) and dispatches to the collator 318 (the JMS client). The collated data queue 319 may act as an intermediary that receives collated data from the collator 318 (the JMS producer) and dispatches to a JMS client.

The queue-topic converter 312, which operates according to a publisher/subscriber messaging model rather than a point-to-point model, may be included so that the same harvested data and associated XML file may be processed in parallel by multiple analytical programs in the one or more natural language processors 314. Examples of functions that may be performed by the one or more natural language processors include determining the implied sentiment of the content (i.e., is the content describing a topic of interest in a positive or negative light), extracting entities identified within text; automatic summarization activities; tracking mentions of entities (e.g. people or companies); linking entity mentions to database entries; uncovering relations between entities and actions; classifying text by reading/writing level or style; classifying text passages by language, character encoding, genre, topic, or sentiment; correcting spelling with respect to a text collection; clustering documents by implicit topic and discovering significant trends over time; providing part-of-speech tagging and phrase chunking; and determining the quality or relevance of changes, updates or deletions to content.

Because various analyses of the harvested data and associated XML file are performed in parallel, with results completed at different times depending on the harvested data content and the analytical process performed, collator 318 groups the results from the one or more natural language processors 314 and changed content quality calculator 316 and re-associates the results with the harvested data and related XML object file. In general, processes for collating data from multiple data sources are well known in the art. Accordingly, further detail of the collating functionality will not be described herein.

An analytical program within the one or more natural language processors 314 may be the changed content quality calculator 316, described in further detail below. One or more natural language processors 314 and specifically changed content quality calculator 316 can also be connected to an external memory 320. External memory 320 can include a database of relevant keywords for use by the changed content quality calculator 316 or the one or more natural language processors 314.

Changed Content Quality Calculator:

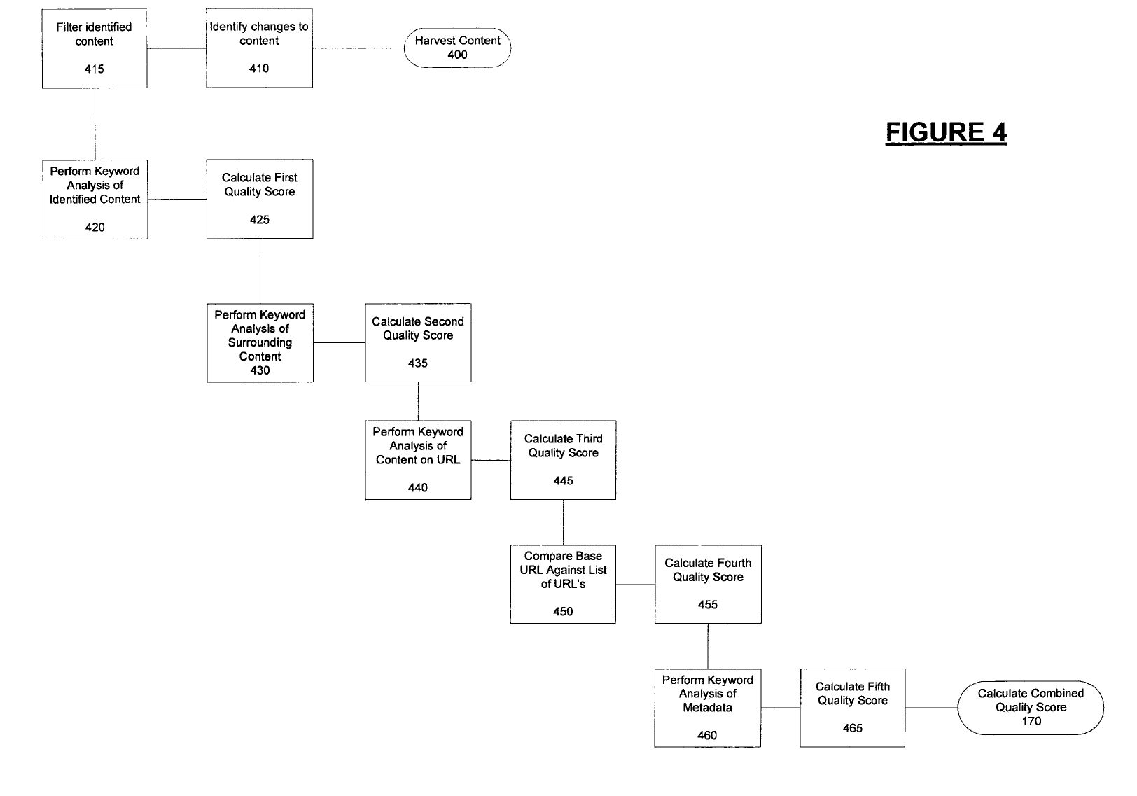

FIG. 4 depicts a flow chart of an exemplary method for calculating the quality of content changes. In the implementation depicted therein, content is harvested 400, for example as described with regard the content harvesting and acquisition function above. The content can include webpages, blog postings, or other information available on the Internet or over a network. Changes/updates/deletions in the content are identified 410. The identified changed content is filtered 415 to further identify and remove meaningless irrelevant, or non-material content often found in unstructured data sets. Examples of non-material content changes include, for example, advertisements, date and time changes, site admin postings, and the like. The identified changed content may be evaluated to determine if any changed content remains after filtering. If no content remains, the calculation is terminated.

Should content remain after filtering, however, the identified content is analyzed 420 for the occurrence of predetermined keywords. Such keywords can include any word or word pair associated with or relevant to a particular area of interest, industry, industry segment, common theme, business, company, event, or any other subject of interest. The occurrence of such predetermined keywords within the identified content is tabulated and a first quality score is calculated 425 based on the relative occurrence of such keywords within the identified content. For example, a document that contains the word “earnings,” “interest,” or “sales goals” would score higher for financial services analysis than such documents that contain the words “sports,” “scores,” or “entertainment tonight.” There are any number of rules or algorithms that can be applied to calculate the first quality score, such as, for example, a simple adding algorithm that adds one “point” every time a predetermined specific word (or word pair) is discovered or found. Another example is a more complex algorithm that assigns a point score maximum for any given word and assigns points or fractions of points depending on the specific word or word pair. The scores can then be tabulated. The scores can also be summed or given a weighted score.

After determining a first quality score, additional analysis can include a keyword analysis 130 of the text or content surrounding the identified content (e.g., searching the unchanged content adjacent the changed content for the occurrence of the keywords). For example, if the third paragraph includes changed or updated data, the changed content quality calculator can look to the text leading up to the third paragraph to see if any predetermined keywords appear. The calculator may look to a preset number of characters, sentences, paragraphs or the like leading to the changed content to perform keyword analysis 430. For example, the calculator could analyze the 300 characters leading up to the identified content change and/or the 300 characters following the identified content change for the occurrence of predetermined keywords. The relative occurrence of keywords within the surrounding text or content can be tabulated. A second quality score 435 is then determined based on the tabulated score. The second quality score can use similar scoring algorithms to those described with regard to the first quality score. The second quality score can use the same or different scoring algorithm as the first quality score. The second quality score can be weighted. The second quality score can be a weighted sum of the first quality score, and the tabulated scored keyword analysis 430.

A further keyword analysis 440 can be performed on the URL from which the identified changed content was found. For example, the URL where the identified content came from can be searched for the occurrence of predetermined keywords within documents or other content that is linked to or found on the same domain as the identified changed content. The relative occurrence of keywords within keyword analysis 440 may be tabulated to form a tabulated score. A third quality score 445 can be determined from the tabulated score. The third quality score can use similar scoring algorithms to those described with regard to the first or second quality score. The third quality score can use the same or different scoring algorithm as the first or second quality scores. The third quality score can be weighted. The third quality score can be a weighted sum of the first and second quality scores, and the tabulated scored keyword analysis 440. The third quality score can be a useful indicator of the relevance of the other content to the needs of, for example, an analyst or investor because content (e.g., webpages) that have useful information for an analyst or investor tend to be grouped or linked together.

A fourth quality score can be determined based on whether the base URL matches a pre-existing list of trusted or reputable URL's. A comparison 450 is made between the base URL and a pre-existing list of URL's. For example, the base URL is run against a database of known content (e.g., known pages) which are useful and if there is a match between the base URL and the database, a fourth quality score 455 is calculated based on the match. The fourth quality score can be a weighted sum of the first, second, and third quality scores, and the matched score of comparison 450.

An additional keyword analysis 460 can be performed to analyzing the meta-data, headers, or titles 460 associated with the identified changed content for the relative occurrence of the predetermined keywords. The relative occurrence of such keywords can form a tabulated score. A fifth quality score 465 is determined based the keyword analysis 460 and may include the tabulated score. The fifth quality score 465 can use similar scoring algorithms to those described with regard to the first, second and third quality scores. The fifth quality score 465 can use the same or different scoring algorithm as the first, second, or third quality scores. The fifth quality score 465 can be weighted. The fifth quality score can be a weighted sum of the first, second, third and fourth quality scores and tabulated scored keyword analysis 460.

A total quality score for the identified content can be achieved by calculating the total additive score of the first, second, third, fourth and fifth quality scores. Alternatively, the first, second, third, fourth and fifth quality scores can be weighted to determine a weighted total quality score. Alternatively, the total quality score can be the fifth quality score.

In an implementation, the identified content and calculated content quality score can be pushed, using a push engine 330, to one or more end user terminals for display to an end user. Delivery may be accomplished using push technologies such as streaming HTTP and Comet programming techniques. HTTP streaming is a mechanism for sending data from a Web server to a Web browser in response to an event. HTTP Streaming is achieved through several common mechanisms. In one such mechanism the web server does not terminate the response to the client after data has been served. This differs from the typical HTTP cycle in which the response is closed immediately following data transmission. The web server leaves the response open such that if an event is received, it can immediately be sent to the client. Otherwise the data would have to be queued until the client's next request is made to the web server. The act of repeatedly queing and re-requesting information is known as a polling mechanism. Typical uses for HTTP Streaming include market data distribution (stock tickers), live chat/messaging systems, online betting and gaming, sport results, monitoring consoles and Sensor network monitoring. Examples of push technology include Virgil's One, SmartClient, Lightstreamer, Pjax, and Pushlets.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Although the present invention has been described in detail with reference to certain implementations, other implementations are possible. Therefore, the spirit and scope of the appended claims should not be limited to the description of implementations contained herein.

What is claimed is:

1. A method for evaluating changes to internet content comprising:
harvesting content wherein the content includes changed content;
filtering the harvested content;
performing one or more keyword analyses on the harvested content from a predetermined list of one or more keywords; and
calculating a score based on the one or more keyword analyses.

2. The method of claim 1 wherein the step of filtering includes identifying non-material changes to the content.

3. The method of claim 1 wherein the step of performing one or more keyword analyses comprises performing a first keyword analysis, second keyword analysis, a third keyword analysis, and a fourth keyword analysis.

4. The method of claim 3 further comprising calculating a quality score for each of the first keyword analysis, the second keyword analysis, the third keyword analysis and the fourth key word analysis.

5. The method of claim 1 wherein at least one of the one or more keyword analyses identifies one or more keywords within the harvested changed content.

6. The method of claim 1 wherein at least one of the one or more keyword analyses identifies one or more keywords in content surrounding the changed content.

7. The method of claim 1 wherein at least one of the one or more keyword analyses identifies one or more keywords in content sharing the same URL as the harvested content.

8. The method of claim 1 wherein at least one of the one or more keyword analyses identifies one or more keywords within meta-data associated with the harvested content.

9. The method of claim 1 further comprising comparing the URL of the harvested content against a list of URL's and determining a URL quality score.

10. The method of claim 1 wherein the quality score is a weighted score

11. The method of claim 4 wherein the quality score is a sum of the quality scores for the first, second, third, and fourth keyword analyses.

12. The method of claim 1 wherein the quality score is a sum of a quality score associated with the one or more keyword analyses and a URL quality score.

13. A system for evaluating changes to internet content comprising:
a content harvester;
a content quality calculator;
means within content harvestor for acquiring content having changed content;
means for analyzing the acquired content and changed content for the occurrence of predetermined keywords;
means for determining a quality score associated with the changed content; and
means for displaying the content, the changed content, and the quality score.

14. The system of claim 13 wherein the means for analyzing the content and changed content comprises a filter for identifying non-material changed content.

15. The system of claim 13 wherein the means for analyzing the content and changed content comprises one or more keyword analyses based on a predetermined list of one or more keywords.

16. The system of claim 15 wherein the keyword analysis is directed to the changed content.

17. The system of claim 15 wherein the keyword analysis is directed to content surrounding the changed content.

18. The system of claim 15 further comprising:
means within the content harvestor for acquiring content having changed content and a URL; and
means for analyzing the acquired content and changed content wherein the keyword analysis is directed to content found on a URL common to the URL of the changed content.

19. The system of claim 15 further comprising a means for comparing a URL associated with the harvested content against a predetermined list of URL's

20. The system of claim 15 wherein the quality score determined based on one or more keyword analyses.
